(19) United States
(12) Patent Application Publication
(10) Pub. No.: US 2025/0304069 A1
(43) Pub. Date: Oct. 2, 2025

(54) CONTROL DEVICE, CONTROL METHOD, AND STORAGE MEDIUM

(71) Applicant: HONDA MOTOR CO, LTD., Tokyo (JP)

(72) Inventor: Hironori HIRATA, Tokyo (JP)

(73) Assignee: HONDA MOTOR CO, LTD., Tokyo (JP)

(21) Appl. No.: 19/066,168

(22) Filed: Feb. 28, 2025

(30) Foreign Application Priority Data
Mar. 27, 2024 (JP) 2024-050851

(51) Int. Cl. B60W 30/18; B60W 10/18; B60W 30/06; G05D 1/226; G05D 109/10; G05D 111/30

(52) U.S. Cl. CPC B60W 30/181; B60W 10/18; B60W 30/06; G05D 1/226; B60W 2520/10; B60W 2530/10; G05D 2109/10; G05D 2111/30

(57) ABSTRACT

A control device for a moving object includes: a communication unit that communicates with an information terminal carried by a user of the moving object; a control unit that performs movement control on the moving object based on an instruction from the information terminal; and a movement state acquisition unit that acquires a movement state of the moving object. The instruction from the information terminal is a movement instruction to move the moving object or a stop instruction to stop the moving object. In response to the stop instruction while the moving object is being moved based on the movement instruction, the control unit stops the moving object with a braking force corresponding to the movement state.

This application is based upon and claims the benefit of priority from prior Japanese patent application No. 2024-50851, filed on Mar. 27, 2024, the entire contents of which are incorporated herein by reference.

### TECHNICAL FIELD

The present disclosure relates to a control device, a control method, and a storage medium storing a control program.

### BACKGROUND ART

In recent years, efforts have been made to provide access to a sustainable transportation system in consideration of people vulnerable among traffic participants. In order to implement the above, focus has been placed on research and development on further improving safety and convenience of traffic by research and development related to self-driving techniques.

In the related art, there is known a remote parking system that remotely operates a vehicle using a smartphone to park the vehicle in a designated predetermined parking space or to cause the vehicle to exit from a parking space.

For example, CN112000089A describes an automatic vehicle addressing system that includes a remote controller that transmits an emergency stop instruction via a wireless network, and a controller that controls the vehicle to stop in emergency based on the emergency stop command transmitted from the remote controller. CN111016884A describes an intelligent parking system including an emergency stop button that can brake the vehicle in response to an operation of a driver in emergency. US 2018/0147988 A1 describes an autonomous vehicle that receives a user input selecting an emergency stop area from at least one of an available stop area or a recommended stop area, and controls the vehicle to stop in the emergency stop area.

### SUMMARY OF INVENTION

In a remote parking system in the related art, when a vehicle stop operation is performed using a smartphone while the vehicle is moving, the vehicle is controlled to stop at a constant deceleration regardless of the movement state of the vehicle at that time. As a result, for example, differences in the movement speed of the vehicle may result in differences in a distance traveled from when the stop operation is performed until the vehicle actually stops or a time it takes to stop. For this reason, depending on the movement state of the vehicle, a user may not be able to easily stop the vehicle using the smartphone. CN112000089A, CN111016884A and US 2018/0147988 A1 do not describe any countermeasures for this stop operation.

Aspects of the present disclosure relate to providing a control device, a control method, and a storage medium storing a control program that can improve operability of movement operation of a moving object using an information terminal.

According to an aspect of the present disclosure, there is provided a control device for a moving object, the control device including:
a communication unit that communicates with an information terminal carried by a user of the moving object;
a control unit that performs movement control on the moving object based on an instruction from the information terminal; and
a movement state acquisition unit that acquires a movement state of the moving object, in which
the instruction from the information terminal is a movement instruction to move the moving object or a stop instruction to stop the moving object, and
in response to the stop instruction while the moving object is being moved based on the movement instruction, the control unit stops the moving object with a braking force corresponding to the movement state.

According to another aspect of the present disclosure, there is provided a control method of a moving object including a communication unit that communicates with an information terminal carried by a user of the moving object, a control unit that performs movement control on the moving object based on an instruction from the information terminal, and a movement state acquisition unit that acquires a movement state of the moving object,
the instruction from the information terminal being a movement instruction to move the moving object or a stop instruction to stop the moving object, the control method including:
in response to the stop instruction while the moving object is being moved based on the movement instruction, stopping, by the control unit, the moving object with a braking force corresponding to the movement state.

According to another aspect of the present disclosure, there is provided a non-transitory computer-readable storage medium storing a control program for a moving object including a communication unit that communicates with an information terminal carried by a user of the moving object, a control unit that performs movement control on the moving object based on an instruction from the information terminal, and a movement state acquisition unit that acquires a movement state of the moving object, the instruction from the information terminal being a movement instruction to move the moving object or a stop instruction to stop the moving object, the control program causing the control unit to execute a process including: in response to the stop instruction while the moving object is being moved based on the movement instruction, stopping the moving object with a braking force corresponding to the movement state.

According to aspects of the present disclosure, a control device, a control method, and a control program that can improve operability of movement operation of a moving object using an information terminal may be provided, thereby contributing to development of a sustainable transportation system.

### BRIEF DESCRIPTION OF DRAWINGS

Exemplary embodiment(s) of the present invention will be described in detail based on the following figures, wherein:

FIG. 1 is a side view of an example of the vehicle 10 equipped with a control device of the present invention;

FIG. 2 is a top view of the vehicle 10 shown in FIG. 1;

FIG. 3 is a block diagram showing an example of an internal configuration of the vehicle 10 shown in FIG. 1;

FIG. 4 is a diagram showing an example of a hardware configuration of an information terminal 60 owned by a user of the vehicle 10;

FIG. 5 is a diagram showing an example of a calling start state in which the user calls for the vehicle;

FIG. 6 is a diagram showing an example of an exit route of a host vehicle V1;

FIG. 7 is a diagram showing an example of a state in which calling for the host vehicle V1 is completed;

FIG. 8 is a flowchart showing an example of processing of the information terminal 60 during calling for the vehicle 10;

FIG. 9 is a diagram showing an example of an operation reception screen 67 displayed on a display screen 66 of the information terminal 60;

FIG. 10 is a diagram showing an example of stop positions of the vehicle 10 when the vehicle 10 with different movement speeds is stopped by stop processing in the related art;

FIG. 11 is a flowchart showing an example of stop processing performed by the vehicle 10 of the present embodiment;

FIG. 12 is a diagram showing an example of stop positions of the vehicle 10 when the vehicle 10 with different movement speeds is stopped by stop processing in the present embodiment;

FIG. 13 is a diagram showing an example of stop positions of the vehicle 10 when the vehicle 10 with different weights is stopped by the stop processing in the related art;

FIG. 14 is a flowchart showing a first modification of the stop processing performed by the vehicle 10 of the present embodiment;

FIG. 15 is a diagram showing stop positions of the vehicle 10 when the vehicle 10 with different weights is stopped by the stop processing in the first modification of the present embodiment;

FIG. 16 is a flowchart showing a second modification of the stop processing performed by the vehicle 10 of the present embodiment; and

FIG. 17 is a flowchart showing a third modification of the stop processing performed by the vehicle 10 of the present embodiment.

### DESCRIPTION OF EMBODIMENTS

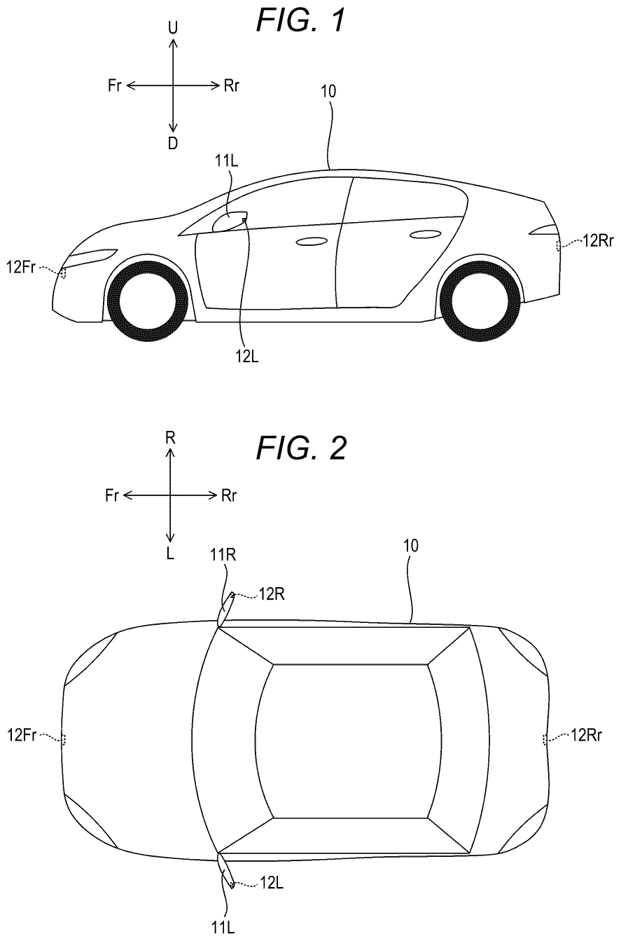

Hereinafter, an embodiment of a control device, a control method, and a storage medium storing a control program in the present disclosure will be described with reference to the accompanying drawings. Note that the drawings are viewed in directions of reference numerals. In order to simplify and clarify the description in the present specification or the like, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

Vehicle 10 Equipped with Control Device

FIG. 1 is a side view of an example of the vehicle 10 equipped with a control device in the present disclosure. FIG. 2 is a top view of the vehicle 10 shown in FIG. 1. The vehicle 10 is an example of a “moving object” in the present disclosure.

The vehicle 10 is an automobile including a drive source (not shown) and wheels including drive wheels driven by power of the drive source and steerable steered wheels. In the present embodiment, the vehicle 10 is a four-wheeled automobile having a pair of left and right front wheels and a pair of left and right rear wheels. The drive source of the vehicle 10 is, for example, an electric motor. Note that the drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

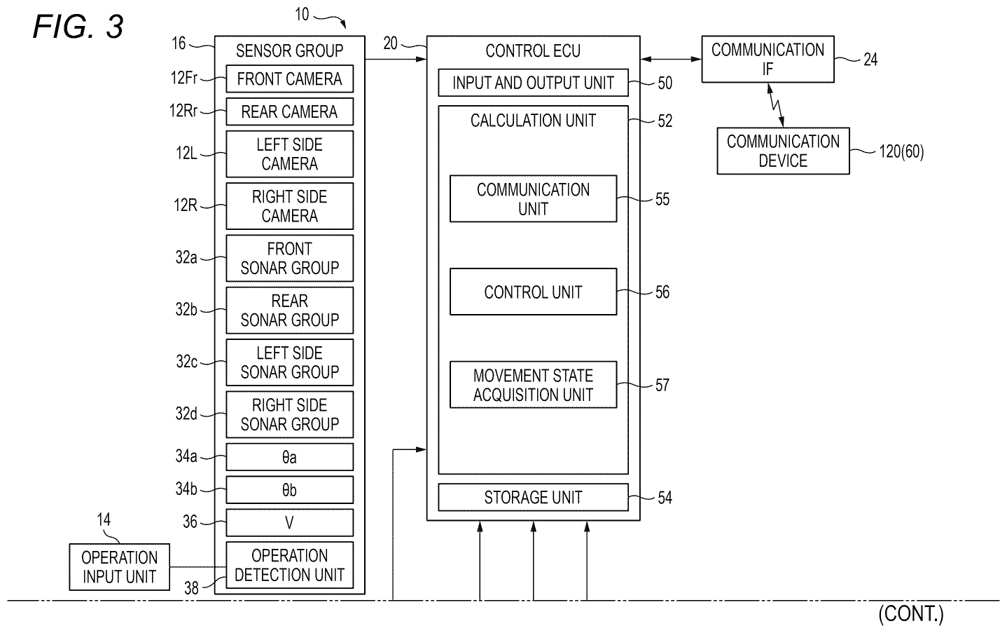

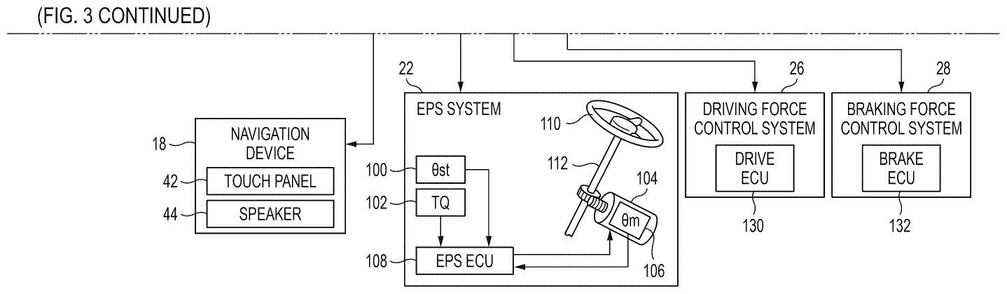

FIG. 3 is a block diagram showing an example of an internal configuration of the vehicle 10 shown in FIG. 1. As shown in FIG. 3, the vehicle 10 includes a sensor group 16, a navigation device 18, a control electronic control unit (ECU) 20, an electric power steering (EPS) system 22 and a communication interface (IF) 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38. The sensor group 16 further includes a weight sensor (not shown) configured to detect of the load of the vehicle 10.

The front camera 12Fr, the rear camera 12Rr, the left side camera 12L, and the right side camera 12R acquire external environment recognition data (for example, peripheral images) for recognizing an external environment of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining captured images from the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20.

The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 by using, for example, a global positioning system (GPS), and guides the user along a route to a destination.

The navigation device 18 includes a storage device (not shown) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes a remote parking button for requesting parking by automatic steering of the control ECU 20, and a support parking button for requesting support while parking the vehicle by an operation of the user. The exiting assistance button includes a remote exiting button for requesting exiting by the automatic steering of the control ECU 20, and a support exiting button for requesting support while exiting by an operation of the user. Note that a constituent element other than the touch panel 42, for example, an information terminal such as a smartphone or a tablet may be used as the input device or the display device.

Note that the “parking” is synonymous with, for example, “parking”. The “parking” is, for example, a stop as an occupant gets on or off the vehicle, and excludes a temporary stop due to a traffic signal or the like. Further, a “parking position” is a position where the moving object (vehicle 10) is stopped, that is, a parking position.

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. The calculation unit 52 receives and outputs signals from and to units connected to the control ECU 20 via the input and output unit 50. The storage unit 54 also stores information related to remote movement (remote parking and remote exiting) of the vehicle 10. The control ECU 20 is an example of a “control device” in the present disclosure.

The calculation unit 52 includes a communication unit 55 that communicates with the outside of the vehicle 10, a control unit 56 that controls remote movement of the vehicle 10, and a movement state acquisition unit 57 that acquires a movement state of the vehicle 10.

The communication unit 55 performs wireless communication with another communication device 120 via the communication IF 24. Another communication device 120 includes a base station, a communication device of another vehicle, an information terminal 60 such as a smartphone or a tablet carried by the user of the vehicle 10, and the like. The communication unit 55 transmits and receives information relating to the remote movement of the vehicle 10 to and from the information terminal 60 and the like via the communication IF 24. The communication unit 55 acquires communication quality between the vehicle 10 and the information terminal 60. The communication quality is detected based on, for example, a received signal strength indicator (RSSI) or an error rate in communication.

The control unit 56 performs remote parking assistance and remote exiting assistance of the vehicle 10 through automatic steering in which a steering 110 is automatically operated under control of the control unit 56. In the remote parking assistance and the remote exiting assistance, an accelerator pedal (not shown), a brake pedal (not shown), and the operation input unit 14 are automatically operated. The control unit 56 performs support parking assistance and support exiting assistance when the user (driver) operates the accelerator pedal, the brake pedal, and the operation input unit 14 to perform manual parking and manual exiting of the vehicle 10. Note that during the remote parking assistance and the remote exiting assistance, the user may be in a state of being present in the vehicle 10, or may be in a state of getting off the vehicle 10 and being outside (not being present in the vehicle).

For example, the control unit 56 performs the movement control for executing movement of the vehicle 10 based on the external environment recognition data of the vehicle 10 acquired by the front camera 12Fr, the rear camera 12Rr, the left side camera 12L, and the right side camera 12R, and a predetermined parking space specified by the user. The movement control includes parking control for remotely parking the vehicle 10 in a predetermined parking space (parking position) and exiting control for remotely causing the vehicle 10 to exit from a parking space to a predetermined target position (exit position).

The control unit 56 executes parking control and exiting control of the vehicle 10 based on an instruction signal input via the input and output unit 50. The received instruction signal includes an instruction signal output from the information terminal 60 or the like carried by the user of the vehicle 10 and transmitted via wireless communication. The instruction from the information terminal 60 or the like includes a “movement instruction” to move the vehicle 10 and a “stop instruction” to stop the vehicle 10. The stop instruction includes a first stop instruction and a second stop instruction. The second stop instruction is an instruction that is output when emergency is higher than when the first stop instruction is output. Hereinafter, the first stop instruction is also referred to as a “normal stop instruction” and the second stop instruction is also referred to as an “emergency stop instruction”.

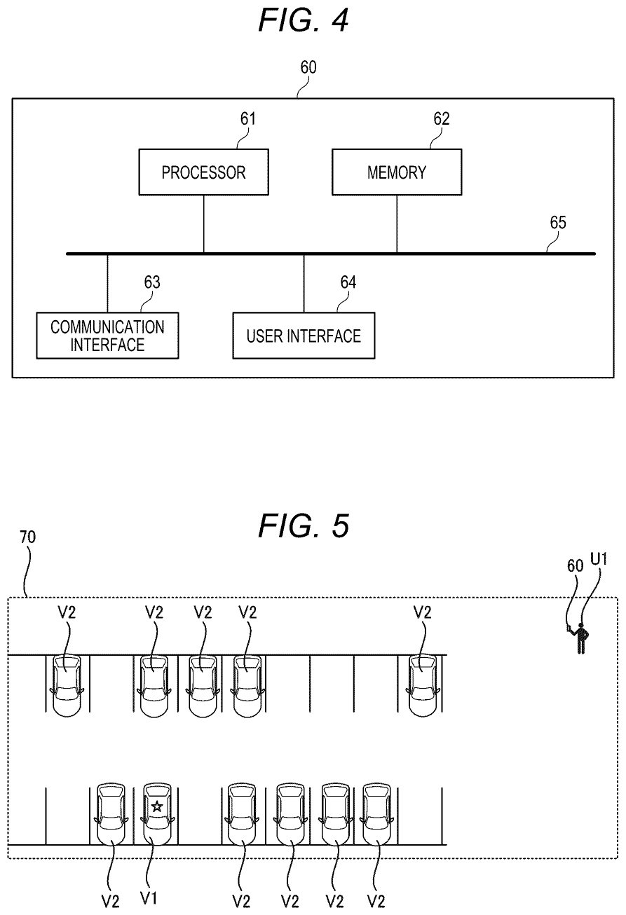

The movement instruction is issued when the information terminal 60 receives a continuous first operation. The “movement instruction” is issued when a movement instruction signal is repeatedly transmitted. The “continuous first operation” is, for example, a specific operation by the user on a display screen of the information terminal 60 (for example, a rotation swiping operation) which will be described later with reference to FIG. 4.

The first stop instruction is issued when the continuous first operation is interrupted. Giving the “first stop instruction” means the movement instruction signal is no longer transmitted. The second stop instruction is issued when the information terminal 60 receives a second operation different from the continuous first operation. Giving the “second stop instruction” means an emergency stop instruction signal is transmitted. The “second operation” is, for example, pressing an emergency stop button or inputting a voice indicating an emergency. While the first operation (specific operation) is continuing, the movement instruction signal continues to be transmitted, and when the first operation is interrupted, the movement instruction signal is no longer transmitted. It should be noted that the instruction from the information terminal 60 is an instruction as to whether to move or stop the vehicle 10, and cannot instruct a speed of the vehicle 10.

Specifically, when a stop instruction is issued while the vehicle 10 is being moved based on a movement instruction, the control unit 56 stops the vehicle 10 with a braking force corresponding to the movement state of the vehicle 10. “In response to a stop instruction” may refer to a case where a stop instruction signal is transmitted from the information terminal 60 to the control unit 56, or a case where the movement instruction signal transmitted from the information terminal 60 to the control unit 56 is no longer transmitted.

In response to a stop instruction while the vehicle 10 is being moved based on a movement instruction, the control unit 56 increases the braking force to stop the vehicle 10 as the movement speed of the vehicle 10 increases. The control unit 56 controls the braking force so that the time and distance required to stop the vehicle 10 do not vary significantly even when the movement speed of the vehicle 10 varies, for example.

In response to a stop instruction while the vehicle 10 is being moved based on a movement instruction, the control unit 56 increases the braking force to stop the vehicle 10 as a weight of the vehicle 10 increases. The control unit 56 controls the braking force so that the time and distance required to stop the vehicle 10 do not vary significantly even when the weight of the vehicle 10 varies, for example.

In response to a stop instruction while the vehicle 10 is being moved based on a movement instruction, the control unit 56 stops the vehicle 10 with a braking force corresponding to the movement state of the vehicle 10 and the communication quality between the vehicle 10 and the information terminal 60. For example, in response to a stop instruction while the vehicle 10 is being moved based on a movement instruction, the control unit 56 increases the braking force to stop the vehicle 10 as the communication quality between the vehicle 10 and the information terminal 60 decreases.

The control unit 56 acquires a delay time from when an instruction signal is transmitted from the information terminal 60 to when the movement control based on the instruction signal is started, and in response to a stop instruction while the vehicle 10 is being moved based on a movement instruction, the control unit 56 stops the vehicle 10 with a braking force corresponding to the movement state of the vehicle 10 and the delay time of communication. For example, in response to a stop instruction is while the vehicle 10 is being moved based on a movement instruction, the control unit 56 increases the braking force to stop the vehicle 10 as the delay time of communication increases.

The “instruction signal” is, for example, a movement instruction signal to move the vehicle 10. Assuming that time is synchronized between the vehicle 10 and the information terminal 60 (or both the vehicle 10 and the information terminal 60 acquire the correct time), for example, the information terminal 60 stores a transmission time of an instruction signal in the instruction signal and transmits the instruction signal to the vehicle 10, and the vehicle 10 that receives the instruction signal acquires the “delay time” based on the transmission time. For example, the delay time is a time obtained by subtracting the transmission time at which the information terminal 60 transmits the instruction signal from the time at which the control unit 56 of the vehicle 10 starts the movement control based on the instruction signal. Alternatively, the delay time may be a time obtained by subtracting the transmission time at which the information terminal 60 transmits the instruction signal from the time at which the control unit 56 of the vehicle 10 receives the instruction signal.

The control unit 56 also stores the delay time of communication when the vehicle 10 is being moved based on a movement instruction, and if a stop instruction is issued while the vehicle 10 is being moved based on the movement instruction, the control unit 56 stops the vehicle 10 with a braking force corresponding to the movement state of the vehicle 10 and the stored delay time. The “stored delay time” is a delay time stored during the immediately previous movement, that is, a delay time that best reflects the current communication state.

When the second stop instruction (emergency stop instruction) is issued, the control unit 56 may increase the braking force to stop the vehicle 10 as compared with when the first stop instruction (normal stop instruction) is issued.

when the vehicle 10 is stopped not based on an instruction from the information terminal 60, the control unit 56 stops the vehicle 10 with a braking force higher than when the vehicle 10 is stopped based on an instruction from the information terminal 60. Examples of the case where the vehicle 10 is stopped not based on an instruction from the information terminal 60 include a case where the vehicle 10 detects an obstacle based on external environment recognition data, or a case where a system failure of the vehicle 10 is detected.

The movement state acquisition unit 57 acquires the movement speed of the vehicle 10 as the movement state of the vehicle 10. The movement state acquisition unit 57 acquires the movement speed of the vehicle 10 based on a vehicle speed V of the vehicle 10 detected by the vehicle speed sensor 36, for example. The movement state acquisition unit 57 also acquires the weight of the vehicle 10. The weight may be acquired by, for example, a weight sensor, or by capturing an image of the vehicle 10 using a camera of the information terminal 60 and acquiring the weight based on the image capturing result (object recognition result), or may be acquired based on a change in the movement speed relative to the driving force. The weight may be acquired before the movement control of the vehicle 10 is performed. The weight of the vehicle 10 may be, for example, a load weight of the vehicle 10, or a sum of the weight of the vehicle 10 and a weight of load.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for an operation of an occupant on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not shown), a calculation unit (not shown), and a storage unit (not shown).

The communication IF 24 enables wireless communication with another communication device 120. For example, the communication IF 24 includes an ultra wide band (UWB) interface or the like that can execute UWB communication with the information terminal 60.

The driving force control system 26 includes a drive ECU 130. The driving force control system 26 executes driving force control of the vehicle 10. The drive ECU 130 controls a driving force of the vehicle 10 by controlling an engine (not shown) or the like based on an operation performed by the user on the accelerator pedal (not shown).

The braking force control system 28 includes a brake ECU 132. The braking force control system 28 executes braking force control of the vehicle 10. The brake ECU 132 controls a braking force of the vehicle 10 by controlling a brake mechanism or the like (not shown) based on an operation performed by the user on the brake pedal (not shown).

### Hardware Configuration of Information Terminal 60 of User

FIG. 4 is a diagram showing an example of a hardware configuration of the information terminal 60 owned by the user of the vehicle 10. The information terminal 60 includes a processor 61, a memory 62, a communication interface 63, and a user interface 64. The processor 61, the memory 62, the communication interface 63, and the user interface 64 are connected by, for example, a bus 65.

The processor 61 is a circuit that executes signal processing, and is, for example, a central processing unit (CPU) that controls the entire information terminal 60. Note that the processor 61 may be implemented by another digital circuit such as a field programmable gate array (FPGA) or a digital signal processor (DSP). The processor 61 may also be implemented by combining a plurality of digital circuits.

The memory 62 includes, for example, a main memory and an auxiliary memory. The main memory is, for example, a random access memory (RAM). The main memory is used as a work area of the processor 61.

The auxiliary memory is a non-volatile memory such as a magnetic disk, an optical disk, or a flash memory. The auxiliary memory stores various programs for operating the information terminal 60. The programs stored in the auxiliary memory are loaded into the main memory and executed by the processor 61.

The auxiliary memory may include a portable memory removable from the information terminal 60. Examples of the portable memory include a universal serial bus (USB) flash drive, a memory card such as a secure digital (SD) memory card, and an external hard disk drive.

The communication interface 63 is a communication interface that executes wireless communication with the outside of the information terminal 60 (for example, the communication IF 24 of the vehicle 10). For example, the communication interface 63 includes a UWB interface for executing UWB communication with the vehicle 10. The communication interface 63 is controlled by the processor 61.

The user interface 64 includes, for example, an input device that receives an operation input from the user and an output device that outputs information to the user. The input device may be implemented by, for example, a touch panel. The output device may be implemented by, for example, a display or a speaker. The user interface 64 is controlled by the processor 61.

The processor 61 executes movement instruction control for instructing movement of the vehicle 10. For example, the processor 61 performs the movement instruction control (including the parking instruction control and the exiting instruction control) on the vehicle 10 based on a specific operation of the user on a display screen of the information terminal 60. The specific operation includes, for example, a tap operation for instructing parking and exiting (calling) of the vehicle 10, and a slide operation for moving the vehicle 10. The slide operation includes a continuous position instruction operation (for example, swiping operation), a rotation instruction operation in a predetermined rotation direction (for example, rotation swiping operation), and the like. The processor 61 further executes control to generate a guidance image for prompting the user to perform an instruction operation on the display screen of the information terminal 60 and display the generated guidance image on the display screen.

The processor 61 transmits, to the vehicle 10, a parking instruction for remotely parking the vehicle 10 and an exiting instruction for remotely causing the vehicle 10 to exit based on a specific operation on the display screen of the information terminal 60. An application configured to make the vehicle 10 to perform automatic movement control (remote parking, remote exiting) by transmitting and receiving information related to the movement control of the vehicle 10 to and from the vehicle 10 is installed in the information terminal 60.

### Vehicle Calling in Parking Lot

Next, vehicle calling in a parking lot 70 will be described with reference to FIGS. 5 to 7.

FIG. 5 is a diagram showing an example of a calling start state in which the user calls for a vehicle. As shown in FIG. 5, it is assumed that a user U1 is intended to call for a host vehicle V1, which is parked in the parking lot 70, using the information terminal 60 carried by the user U1. In addition to the host vehicle V1 of the user U1, a plurality of other vehicles V2 are parked in the parking lot 70. When an application for remotely causing the host vehicle V1 to exit is started on the information terminal 60, face authentication of the user U1 is performed using the camera of the information terminal 60, and then remote exiting of the host vehicle V1 is started in response to the operation of the user U1. The host vehicle V1 is an example of a “moving object” in the present invention.

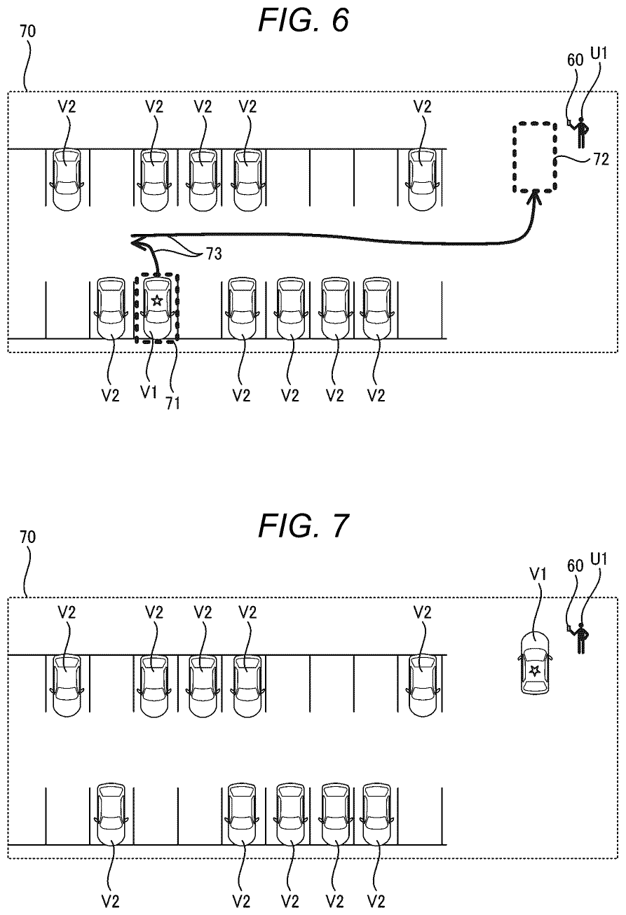

FIG. 6 is a diagram showing an example of an exit route of the host vehicle V1. When the host vehicle V1 receives a movement instruction signal instructing exiting from the information terminal 60, an exit route 73 from a parking position 71 of the host vehicle V1 to an exit position 72 to which the host vehicle V1 is called is generated based on external environment recognition data acquired by the cameras and the like, and movement control of the host vehicle V1 is performed based on the generated exit route 73.

In a case where the parking lot 70 is a large parking lot such as a public parking lot, when a vehicle is called to exit from a parking position to a predetermined exit position, a calling distance may be long depending on the parking position, and therefore, the time it takes for the vehicle to reach the exit position is long and a user who calls for the vehicle needs to perform a remote operation for a long period of time. Therefore, depending on a peripheral environment from the parking position of the vehicle to the exit position, for example, in a case of an exit route which is clear and free of obstacles, movement control may be performed so that the movement speed of the vehicle is faster than a normal exit movement speed.

FIG. 7 is a diagram showing an example of a state in which calling for the host vehicle V1 is completed. The host vehicle V1 changes the movement speed of the host vehicle V1 depending on a distance between the host vehicle V1 and the information terminal 60 and a peripheral environment from the parking position 71 to the exit position 72, and moves to the exit position 72 (see FIG. 6) called by the user U1.

### Processing of Information Terminal 60

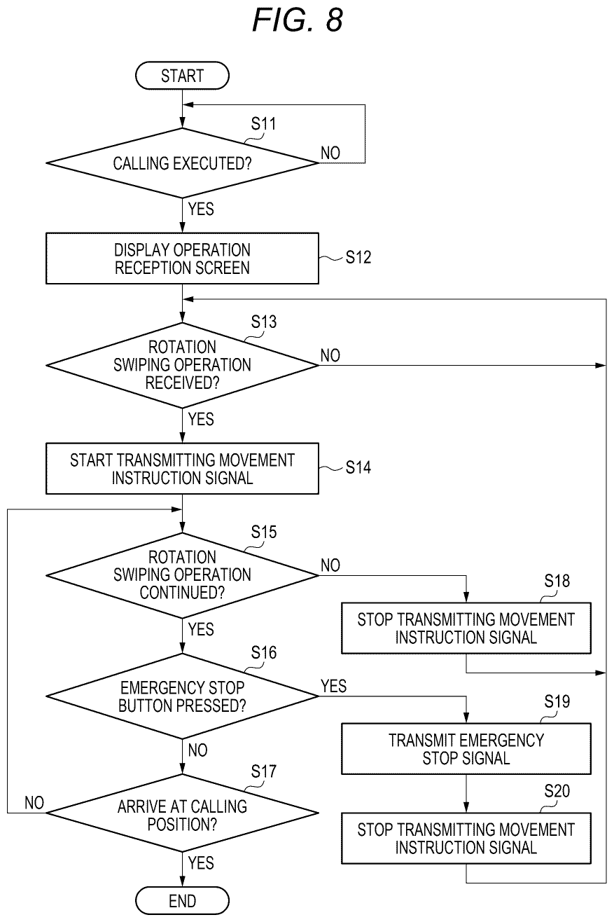

FIG. 8 is a flowchart showing an example of processing of the information terminal 60 during calling for the vehicle 10.

The information terminal 60 (processor 61) determines whether calling is executed by the user to call for the vehicle 10 to the exit position 72 (step S11). The vehicle 10 is called by starting an application for remotely causing the vehicle 10 to exit, which is installed on the information terminal 60, and tapping an execution button.

In step S11, if calling is not executed (step S11: No), the information terminal 60 repeats the determination of step S11. In step S11, if calling is executed (step S11: Yes), the information terminal 60 displays an operation reception screen for receiving a calling operation from the user on the display screen of the information terminal 60 (step S12).

Next, the information terminal 60 determines whether a rotation swiping operation (specific operation) from the user on the operation reception screen is received (step S13).

In step S13, if no rotation swiping operation is received (step S13: No), the information terminal 60 repeats the determination of step S13. In step S13, if a rotation swiping operation is received (step S13: Yes), the information terminal 60 starts transmitting a movement instruction signal that is output based on the rotation swiping operation (step S14).

Next, the information terminal 60 determines whether the rotation swiping operation on the operation reception screen is continued (step S15).

In step S15, if the rotation swiping operation is continued (step S15: Yes), the information terminal 60 determines whether the emergency stop button on the operation reception screen is pressed (step S16).

In step S16, if the emergency stop button is not pressed (step S16: No), the information terminal 60 determines whether the vehicle 10 arrives at the calling position, which is the exit position to which the vehicle 10 is called (step S17).

In step S17, if the vehicle 10 does not arrive at the calling position (step S17: No), the information terminal 60 returns to step S15 and repeats the processing of each step. In step S17, if the vehicle 10 arrives at the calling position (step S17: Yes), the information terminal 60 ends this processing.

On the other hand, in step S15, if the rotation swiping operation is not continued (step S15: No), the information terminal 60 stops transmitting the movement instruction signal (step S18), and then returns to step S13 to repeat the processing of each step.

On the other hand, if the emergency stop button is pressed in step S16 (step S16: Yes), the information terminal 60 transmits an emergency stop signal instructing an emergency stop of the vehicle 10 (step S19). Then, the information terminal 60 stops transmitting the movement instruction signal (step S20), and then returns to step S13 and repeats the processing of each step.

### Display Screen of Information Terminal 60

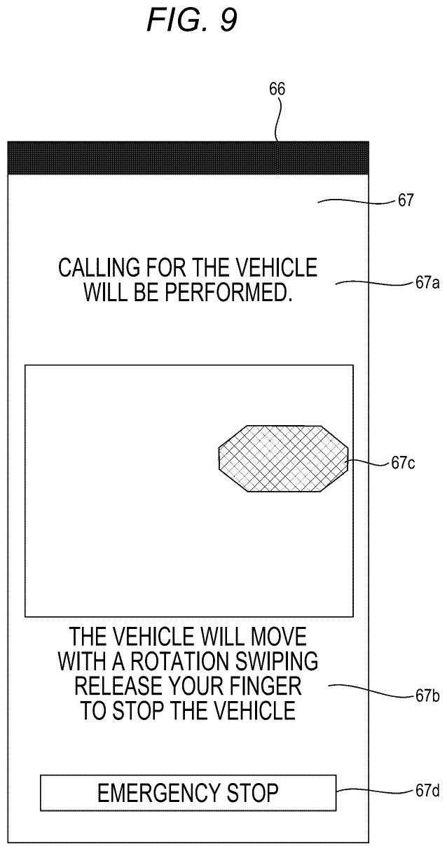

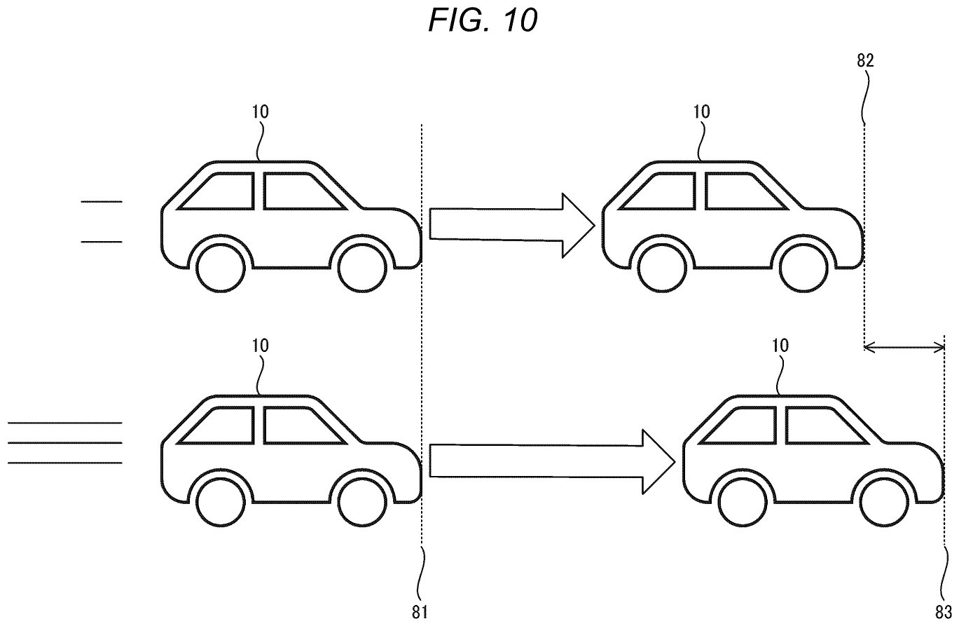

FIG. 9 is a diagram showing an example of an operation reception screen 67 displayed on a display screen 66 of the information terminal 60. The operation reception screen 67 is an example of the screen displayed in step S12 of FIG. 8. The user can call the vehicle 10 to the exit position by performing a specific operation on the operation reception screen 67.

As shown in FIG. 9, the operation reception screen 67 displays a message 67a such as “Calling for the vehicle will be performed.” The operation reception screen 67 also displays a guide message 67b that provides guidance on an operation content, such as “The vehicle will be moved by rotation swiping. Release your finger to stop the vehicle.” The operation reception screen 67 displays, for example, a moving icon 67c that moves following a touch position of the user in a rotation swiping operation. Furthermore, the operation reception screen 67 displays an “emergency stop” button 67d for causing an emergency stop of the vehicle 10.

### Stop Processing of Vehicle 10 in Related Art

FIG. 10 is a diagram showing an example of stop positions of the vehicle 10 when the vehicle 10 with different movement speeds is stopped by stop processing in the related art.

In the movement control on the vehicle 10 in the related art, when the movement instruction signal is no longer transmitted from the information terminal 60 and continuous reception of the movement instruction signal in the vehicle 10 is interrupted, the vehicle 10 stops moving, as shown in FIG. 10. In other words, the vehicle 10 stops the movement of the vehicle 10 with a constant braking force regardless of the movement speed of the vehicle 10 from the position where the movement instruction signal is no longer transmitted from the information terminal 60, that is, a stop start position 81 where the stop instruction is issued to the vehicle 10. Therefore, depending on the movement speed of the vehicle 10, the stop position where the vehicle 10 stops and the time it takes to stop will differ. For example, when the movement speed of the vehicle 10 shown in an upper part of FIG. 10 is a first speed V01, the stop position of the vehicle 10 is a first stop position 82, whereas when the movement speed of the vehicle 10 shown in a lower part is a second speed V02 which is faster than the first speed V01, the stop position of the vehicle 10 is a second stop position 83, and the faster the movement speed, the longer the distance and time required to stop the vehicle 10.

### Stop Processing of Vehicle 10 in Present Embodiment

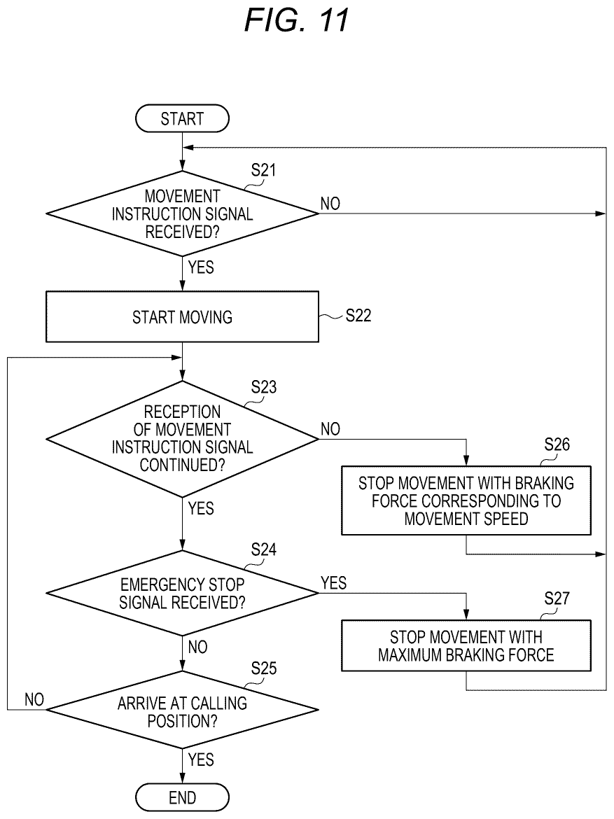

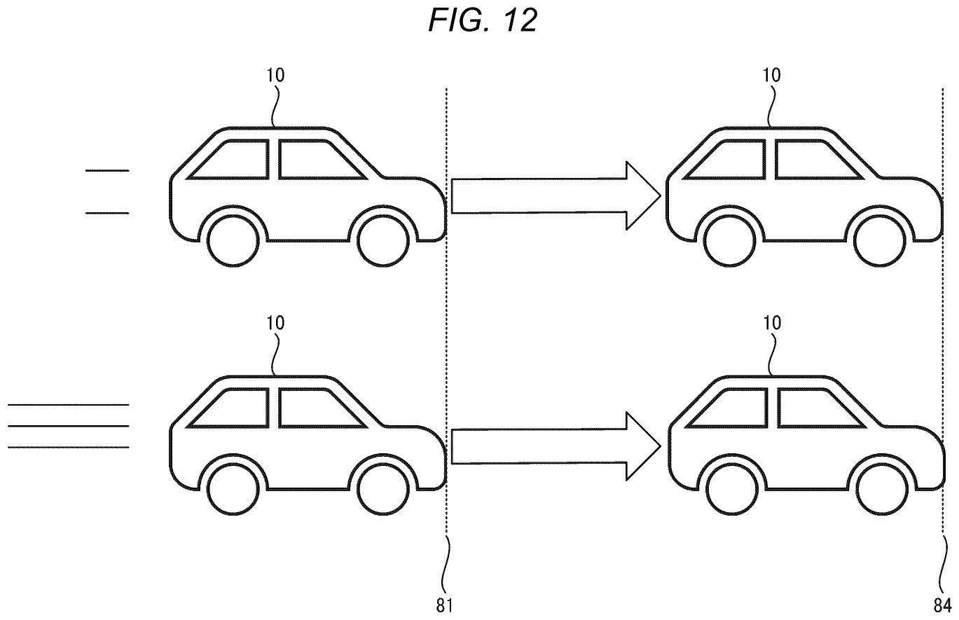

FIG. 11 is a flowchart showing an example of stop processing performed by the vehicle 10 of the present embodiment.

The vehicle 10 (control ECU 20) determines whether a movement instruction signal instructing movement of the vehicle 10 is received from the information terminal 60 (step S21).

In step S21, if a movement instruction signal is not received from the information terminal 60 (step S21: No), the vehicle 10 repeats the determination of step S21. In step S21, if a movement instruction signal is received from the information terminal 60 (step S21: Yes), the vehicle 10 starts moving according to the movement instruction (rotation swiping operation) from the information terminal 60 (step S22).

Next, the vehicle 10 determines whether the reception of the movement instruction signal from the information terminal 60 is continued (step S23).

In step S23, if the reception of the movement instruction signal is continued (step S23: Yes), the vehicle 10 determines whether an emergency stop signal is received from the information terminal 60 (step S24).

In step S24, if no emergency stop signal is received (step S24: No), the vehicle 10 determines whether the vehicle 10 arrives at the calling position (exit position) called by the information terminal 60 (step S25).

In step S25, if the vehicle 10 does not arrive at the calling position (step S25: No), the vehicle 10 returns to step S23 and repeats the processing of each step. In step S25, if the vehicle 10 arrives at the calling position (step S25: Yes), the vehicle 10 ends this processing.

On the other hand, in step S23, if the reception of the movement instruction signal is not continued (step S23: No), the vehicle 10 stops the movement of the vehicle 10 with a braking force corresponding to the movement speed of the vehicle 10 (step S26). After stopping the movement, the vehicle 10 returns to step S21 and repeats the processing of each step. The braking force corresponding to the movement speed means, for example, that the braking force is increased as the movement speed is increased.

On the other hand, if an emergency stop signal is received in step S24 (step S24: Yes), the vehicle 10 stops the movement of the vehicle 10 with a maximum braking force (step S27). After stopping the movement, the vehicle 10 returns to step S21 and repeats the processing of each step.

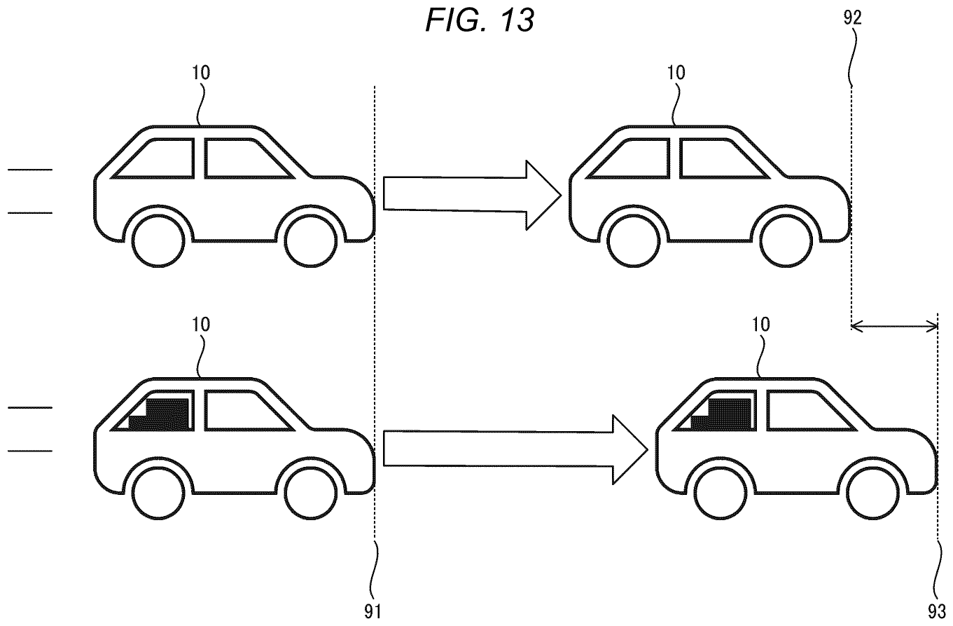

FIG. 12 is a diagram showing an example of stop positions of the vehicle 10 when the vehicle 10 with different movement speeds is stopped by the stop processing in the present embodiment.

In the movement control on the vehicle 10 in the present embodiment, when the movement instruction signal is no longer transmitted from the information terminal 60 and continuous reception of the movement instruction signal in the vehicle 10 is interrupted, the vehicle 10 stops moving, as shown in FIG. 12. In other words, the movement of the vehicle 10 is stopped with a braking force corresponding to the movement speed of the vehicle 10 from the position where the movement instruction signal is no longer transmitted from the information terminal 60, that is, the stop start position 81 where the stop instruction is issued to the vehicle 10. Therefore, even when the movement speed of the vehicle 10 differs, the vehicle 10 can be stopped without causing a large difference in the stop position. For example, even when the movement speed of the vehicle 10 shown in an upper part of FIG. 12 is the first speed V01 and the movement speed of the vehicle 10 shown in a lower part is the second speed V02 which is faster than the first speed V01, by stopping the vehicle 10 shown in the lower part which has the faster movement speed with a high braking force, the vehicle 10 can be stopped at a stop position 84 which has approximately the same distance from the stop start position 81.

As described above, when a stop instruction to stop the vehicle 10 is issued by the information terminal 60 while the vehicle 10 is being moved based on a movement instruction from the information terminal 60, the control device of the present embodiment stops the vehicle 10 with a braking force corresponding to the movement speed of the vehicle 10. In this way, regardless of the movement speed of the vehicle 10, the vehicle 10 is stopped at approximately the same distance after the user gives the stop instruction, thereby making it easier to get a feel for where the vehicle 10 will stop. Therefore, it is easy to know, for example, a timing to stop a specific operation (rotation swiping operation), thereby improving operability of the movement operation of the vehicle 10 using the information terminal 60.

### Stop Processing of Vehicle 10 in Related Art

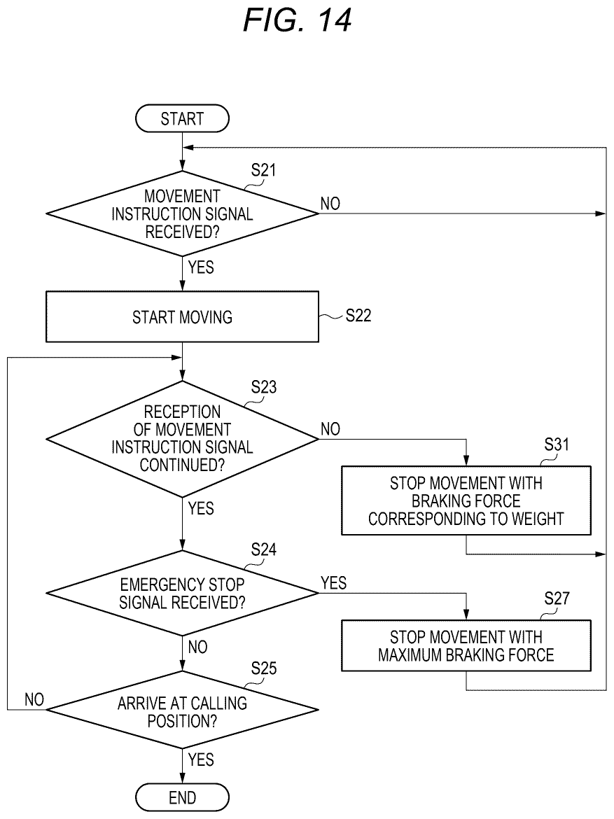

FIG. 13 is a diagram showing an example of stop positions of the vehicle 10 when the vehicle 10 with different weights is stopped by the stop processing in the related art.

In the movement control on the vehicle 10 in the related art, when the continuous reception of the movement instruction signal in the vehicle 10 is interrupted, as shown in FIG. 13, the vehicle 10 stops the movement of the vehicle 10 with a constant braking force regardless of the weight of the vehicle 10 from a stop start position 91 where the stop instruction is issued.

Therefore, depending on the weight of the vehicle 10, the stop position where the vehicle 10 stops and the time it takes to stop will differ. For example, when the weight of the vehicle 10 shown in an upper part of FIG. 13 is, for example, a first weight M1, the stop position of the vehicle 10 is a first stop position 92, whereas when the weight of the vehicle 10 shown in a lower part is a second weight M2 which is larger than the first weight M1, the stop position of the vehicle 10 is a second stop position 93, and the larger the weight, the longer the distance and time required to stop the vehicle 10.

### Stop Processing of Vehicle 10 in Present Embodiment

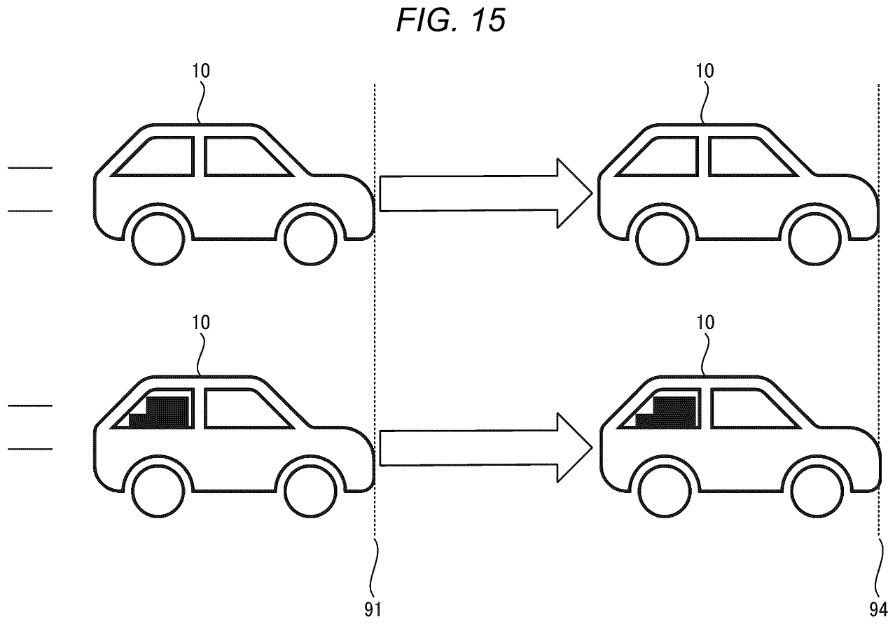

FIG. 14 is a flowchart showing a first modification of the stop processing performed by the vehicle 10 of the present embodiment. As shown in FIG. 14, the processing from step S21 to step S25 and the processing of step S27 are similar to the processing from step S21 to step S25 and the processing of step S27 in FIG. 11.

In step S23, if the reception of the movement instruction signal is not continued (step S23: No), the vehicle 10 stops the movement of the vehicle 10 with a braking force corresponding to the weight of the vehicle 10 (step S31). After stopping the movement, the vehicle 10 returns to step S21 and repeats the processing of each step. The braking force corresponding to the weight means, for example, that the braking force is increased as the weight increases.

Note that in the first modification, the movement is stopped with a braking force corresponding only to the weight of the vehicle 10, but the present invention is not limited thereto. For example, the movement of the vehicle 10 may be stopped with a braking force corresponding to the weight and the movement speed of the vehicle 10.

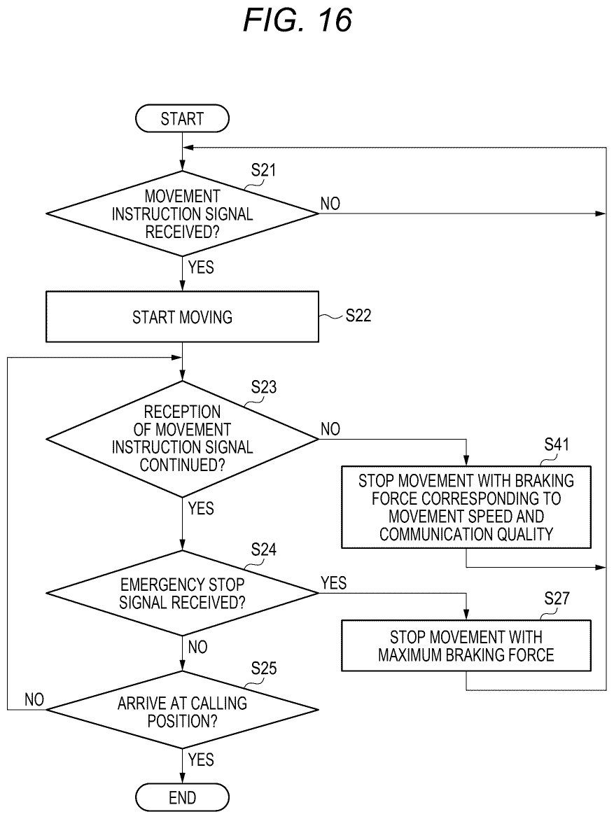

FIG. 15 is a diagram showing stop positions of the vehicle 10 when the vehicle 10 with different weights is stopped by the stop processing in the first modification of the present embodiment.

In the movement control on the vehicle 10 in the first modification, when the continuous reception of the movement instruction signal in the vehicle 10 is interrupted, as shown in FIG. 15, the vehicle 10 stops the movement of the vehicle 10 with a braking force corresponding to the weight of the vehicle 10 from the stop start position 91 where the stop instruction is issued. Therefore, even when the weight of the vehicle 10 differs, the vehicle 10 can be stopped without causing a large difference in the stop position. For example, even when the weight of the vehicle 10 shown in an upper part of FIG. 15 is the first weight M1 and the weight of the vehicle 10 shown in a lower part is the second weight M2 which is larger than the first weight M1, by stopping the vehicle 10 shown in the lower part which has the larger weight with a high braking force, the vehicle 10 can be stopped at a stop position 94 which has approximately the same distance from the stop start position 91.

As described above, when a stop instruction to stop the vehicle 10 is issued by the information terminal 60 while the vehicle 10 is being moved based on a movement instruction from the information terminal 60, the control device of the first modification stops the vehicle 10 with a braking force corresponding to the weight of the vehicle 10. In this way, regardless of the weight of the vehicle 10, the vehicle 10 is stopped at approximately the same distance after the user gives the stop instruction, thereby making it easier to get a feel for where the vehicle 10 will stop. Therefore, it is easy to know, for example, a timing to stop a specific operation (rotation swiping operation), thereby improving operability of the movement operation of the vehicle 10 using the information terminal 60.

### Stop Processing of Vehicle 10 in Present Embodiment

FIG. 16 is a flowchart showing a second modification of the stop processing performed by the vehicle 10 of the present embodiment. As shown in FIG. 16, the processing from step S21 to step S25 and the processing of step S27 are similar to the processing from step S21 to step S25 and the processing of step S27 in FIG. 11.

In step S23, if the reception of the movement instruction signal is not continued (step S23: No), the vehicle 10 stops the movement of the vehicle 10 with a braking force corresponding to the movement speed of the vehicle 10, and stops the movement of the vehicle 10 with a braking force corresponding to the communication quality with the information terminal 60 (step S41). After stopping the movement, the vehicle 10 returns to step S21 and repeats the processing of each step. The braking force corresponding to the communication quality means that, for example, the braking force is increased as the communication quality (RSSI or error rate) is decreased. The braking force corresponding to the movement speed and the communication quality means that the braking force that results in a constant stop position corresponding to the movement speed is used as a reference, and when the communication quality is low, the braking force is increased to reduce a risk caused by communication instability.

Note that in the second modification, the movement is stopped with a braking force corresponding to the movement speed and the communication quality of the vehicle 10, but the present invention is not limited thereto. For example, the movement of the vehicle 10 may be stopped with a braking force corresponding to the weight and the communication quality of the vehicle 10.

As described above, when a stop instruction to stop the vehicle 10 is issued by the information terminal 60 while the vehicle 10 is being moved based on a movement instruction from the information terminal 60, the control device of the second modification stops the vehicle 10 with a braking force corresponding to the movement state of the vehicle 10 and the communication quality with the information terminal 60. In this way, regardless of the movement state of the vehicle 10 and the communication quality with the information terminal 60, the vehicle 10 is stopped at approximately the same distance after the user gives the stop instruction, thereby making it easier to get a feel for where the vehicle 10 will stop. Therefore, it is easy to know, for example, a timing to stop a specific operation (rotation swiping operation), thereby improving operability of the movement operation of the vehicle 10 using the information terminal 60.

### Stop Processing of Vehicle 10 in Present Embodiment

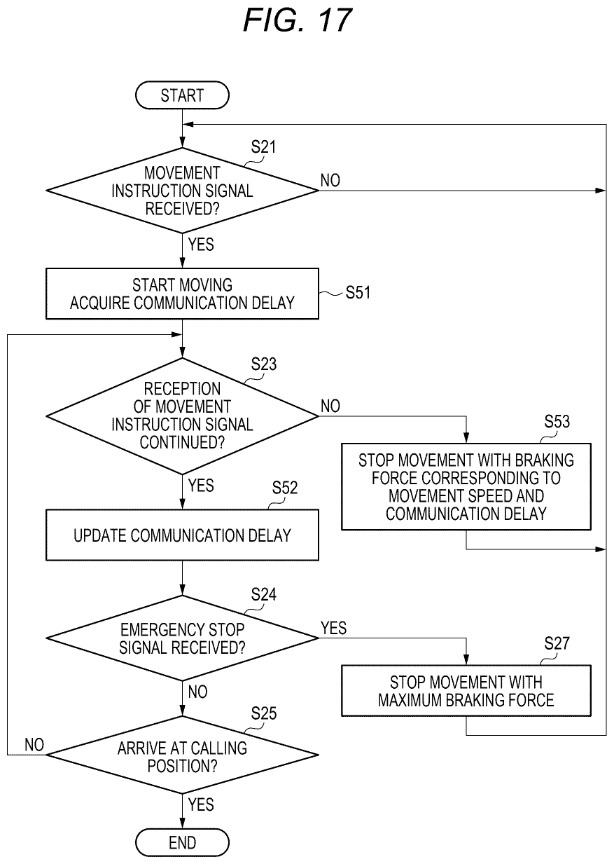

FIG. 17 is a flowchart showing a third modification of the stop processing performed by the vehicle 10 of the present embodiment. As shown in FIG. 17, the processing of step S21, step S23, step S24 to step S25, and step S27 is similar to the processing of step S21, step S23, step S24 to step S25, and step S27 in FIG. 11.

In step S21, if a movement instruction signal is received from the information terminal 60 (step S21: Yes), the vehicle 10 starts moving according to the movement instruction (rotation swiping operation) from the information terminal 60, and acquires a communication delay in the communication with the information terminal 60 (step S51). The communication delay is a time from when the movement instruction signal is transmitted from the information terminal 60 to when the movement control on the vehicle 10 based on the movement instruction signal is started.

Next, the vehicle 10 determines whether the reception of the movement instruction signal from the information terminal 60 is continued (step S23), and if the reception of the movement instruction signal is continued (step S23: Yes), the vehicle 10 updates the stored communication delay time to the communication delay time obtained in step S51 (step S52). On the other hand, in step S23, if the reception of the movement instruction signal is not continued (step S23: No), the vehicle 10 stops the movement of the vehicle 10 with a braking force corresponding to the movement speed of the vehicle 10, and stops the movement of the vehicle 10 with a braking force corresponding to the communication delay time stored in the immediately previous movement (step S53). After stopping the movement, the vehicle 10 returns to step S21 and repeats the processing of each step. The braking force corresponding to the communication delay means that, for example, the braking force is increased as the communication delay time increases.

Note that in the third modification, the movement is stopped with a braking force corresponding to the movement speed and the communication delay of the vehicle 10, but the present invention is not limited thereto. For example, the movement of the vehicle 10 may be stopped with a braking force corresponding to the weight and the communication delay of the vehicle 10.

As described above, when a stop instruction to stop the vehicle 10 is issued by the information terminal 60 while the vehicle 10 is being moved based on a movement instruction from the information terminal 60, the control device of the third modification stops the vehicle 10 with a braking force corresponding to the movement state of the vehicle 10 and the communication delay time. In this way, regardless of the movement state of the vehicle 10 and the communication delay time, the vehicle 10 is stopped at approximately the same distance after the user gives the stop instruction, thereby making it easier to get a feel for where the vehicle 10 will stop. Therefore, it is easy to know, for example, a timing to stop a specific operation (rotation swiping operation), thereby improving operability of the movement operation of the vehicle 10 using the information terminal 60.

Note that the control method described in the embodiment described above may be implemented by executing a control program prepared in advance by a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

The embodiment of the present disclosure has been described above, but the present disclosure is not limited to the embodiment described above, and modifications, improvements, and the like may be made as appropriate.

In the above-described embodiment, an example in which the moving object is a vehicle (four-wheeled automobile) has been described, but the moving object is not limited thereto. For example, the moving object may be a vehicle such as a two-wheeled vehicle or a Segway. Further, the idea of the present disclosure is not limited to the vehicle, and may also be applied to a robot, a ship, an aircraft, or the like that includes a drive source and is movable by power of the drive source.

In the present specification, at least the following matters are described. Although corresponding constituent elements or the like in the embodiment described above are shown in parentheses, the present disclosure is not limited thereto.

(1) A control device (control ECU 20) for a moving object) vehicle 10), the control device including:
a communication unit (communication unit 55) that communicates with an information terminal carried by a user of the moving object;
a control unit (control unit 56) that performs movement control on the moving object based on an instruction from the information terminal; and
a movement state acquisition unit (movement state acquisition unit 57) that acquires a movement state of the moving object, in which the instruction from the information terminal is a movement instruction to move the moving object or a stop instruction to stop the moving object, and in response to the stop instruction while the moving object is being moved based on the movement instruction, the control unit stops the moving object with a braking force corresponding to the movement state.

According to (1), when the stop instruction to stop the moving object is issued from the information terminal while the moving object is being moved based on the movement instruction from the information terminal, the movement of the moving object is stopped with an appropriate braking force corresponding to the movement state of the moving object, thereby improving the operability of the movement operation using the information terminal.

(2) The control device according to (1), in which
the movement state acquisition unit acquires a movement speed of the moving object as the movement state, and
in response to the stop instruction while the moving object is being moved based on the movement instruction, the control unit increases the braking force to stop the moving object as the movement speed of the moving object increases.

According to (2), by stopping the movement of the moving object with a higher braking force as the movement speed of the moving object increases, the movement of the moving object can be stopped without significantly differing in the time or distance required to stop even when the movement speed of the moving object differs.

(3) The control device according to (1) or (2), in which
the movement state acquisition unit acquires a weight of the moving object, and
in response to the stop instruction while the moving object is being moved based on the movement instruction, the control unit increases the braking force to stop the moving object as the weight increases.

According to (3), by stopping the movement of the moving object with a higher braking force as the weight of the moving object increases, the movement of the moving object can be stopped without significantly differing in the time or distance required to stop even when the weight of the moving object differs.

(4) The control device according to any one of (1) to (3), in which
the communication unit acquires communication quality between the moving object and the information terminal, and
in response to the stop instruction while the moving object is being moved based on the movement instruction, the control unit stops the moving object with a braking force corresponding to the movement state and the communication quality.

According to (4), when the stop instruction to stop the moving object is issued from the information terminal while the moving object is being moved based on the movement instruction from the information terminal, the movement of the moving object is stopped with an appropriate braking force corresponding to the movement state of the moving object and the communication quality between the moving object and the information terminal, thereby improving the operability of the movement operation using the information terminal.

(5) The control device according to (4), in which
in response to the stop instruction while the moving object is being moved based on the movement instruction, the control unit increases the braking force to stop the moving object as the communication quality decreases.

According to (5), by stopping the movement of the moving object with a higher braking force as the communication quality between the moving object and the information terminal decreases, the movement of the moving object can be stopped without significantly differing in the time or distance required to stop even when the communication quality between the moving object and the information terminal differs.

(6) The control device according to any one of (1) to (5), in which
the control unit acquires a delay time from when an instruction signal is transmitted from the information terminal to when the movement control based on the instruction signal is started, and
in response to the stop instruction while the moving object is being moved based on the movement instruction, the control unit stops the moving object with a braking force corresponding to the movement state and the delay time.

According to (6), when the stop instruction to stop the moving object is issued from the information terminal while the moving object is being moved based on the movement instruction from the information terminal, the movement of the moving object is stopped with an appropriate braking force corresponding to the movement state of the moving object and the communication delay time, thereby improving the operability of the movement operation using the information terminal.

(7) The control device according to (6), in which
in response to the stop instruction while the moving object is being moved based on the movement instruction, the control unit increases the braking force to stop the moving object as the delay time increases.

According to (7), by stopping the movement of the moving object with a higher braking force as the communication delay time increases, the movement of the moving object can be stopped without significantly differing in the time or distance required to stop even when the delay time differs.

(8) The control device according to (6) or (7), in which
the control unit stores the delay time when the moving object is being moved based on the movement instruction, and
in response to the stop instruction while the moving object is being moved based on the movement instruction, the control unit stops the moving object with a braking force corresponding to the movement state and the stored delay time.

According to (8), a delay time stored in the immediately previous movement of the moving object is used to stop the movement of the moving object with a braking force corresponding to the delay time, thereby improving the operability of the movement operation using the information terminal.

(9) The control device according to any one of (1) to (8), in which
the stop instruction is a first stop instruction or a second stop instruction with a higher emergency than the first stop instruction, and
in response to the second stop instruction, the control unit increases the braking force to stop the moving object as compared with when the first stop instruction is issued.

According to (9), when the second stop instruction, which has a higher emergency than the first stop instruction, is issued, the movement of the moving object is stopped with a braking force higher than when the first stop instruction is issued, thereby stopping the movement of the moving object with an appropriate braking force corresponding to the movement state of the moving object, improving the operability of the movement operation using the information terminal, and at the same time, when a stop instruction with a high emergency is issued, it is possible to achieve stopping in a short time and over a short distance, thereby improving safety.

(10) The control device according to (9), in which
the movement instruction is issued when the information terminal receives a continuous first operation,
the first stop instruction is issued when the continuous first operation is interrupted, and
the second stop instruction is issued when the information terminal receives a second operation different from the continuous first operation.

According to (10), by making the second operation received in the second stop instruction different from the first operation received in the first stop instruction, it is possible to improve the operability of the movement operation using the information terminal.

(11) The control device according to (10), in which
the second operation is at least one of an operation of an emergency stop button and a voice input.

As in (11), the second operation for the second stop instruction, which has a higher emergency, is preferably, for example, an operation on the emergency stop button or a voice input by the user.

(12) The control device according to any one of (1) to (11), in which
when the moving object is stopped not based on an instruction from the information terminal, the control unit stops the moving object with a braking force higher than when the moving object is stopped based on an instruction from the information terminal.

According to (12), when the moving object is stopped not based on an instruction from the information terminal, the movement of the moving object is stopped with a braking force higher than when the moving object is stopped based on an instruction, so that the movement of the moving object can be stopped with an appropriate braking force corresponding to the movement state of the moving object.

(13) A control method of a moving object including a communication unit that communicates with an information terminal carried by a user of the moving object, a control unit that performs movement control on the moving object based on an instruction from the information terminal, and a movement state acquisition unit that acquires a movement state of the moving object, the instruction from the information terminal being a movement instruction to move the moving object or a stop instruction to stop the moving object, the control method including:
in response to the stop instruction while the moving object is being moved based on the movement instruction, stopping, by the control unit, the moving object with a braking force corresponding to the movement state.

According to (13), when the stop instruction to stop the moving object is issued from the information terminal while the moving object is being moved based on the movement instruction from the information terminal, the movement of the moving object is stopped with an appropriate braking force corresponding to the movement state of the moving object, thereby improving the operability of the movement operation using the information terminal.

(14) A non-transitory computer-readable storage medium storing a control program for a moving object including a communication unit that communicates with an information terminal carried by a user of the moving object, a control unit that performs movement control on the moving object based on an instruction from the information terminal, and a movement state acquisition unit that acquires a movement state of the moving object, the instruction from the information terminal being a movement instruction to move the moving object or a stop instruction to stop the moving object, the control program causing the control unit to execute a process including:
in response to the stop instruction while the moving object is being moved based on the movement instruction, stopping the moving object with a braking force corresponding to the movement state.

According to (14), when the stop instruction to stop the moving object is issued from the information terminal while the moving object is being moved based on the movement instruction from the information terminal, the movement of the moving object is stopped with an appropriate braking force corresponding to the movement state of the moving object, thereby improving the operability of the movement operation using the information terminal.

What is claimed is:

1. A control device for a moving object, the control device comprising:
a communication unit that communicates with an information terminal carried by a user of the moving object;
a control unit that performs movement control on the moving object based on an instruction from the information terminal; and
a movement state acquisition unit that acquires a movement state of the moving object, wherein
the instruction from the information terminal is a movement instruction to move the moving object or a stop instruction to stop the moving object, and
in response to the stop instruction while the moving object is being moved based on the movement instruction, the control unit stops the moving object with a braking force corresponding to the movement state.

2. The control device according to claim 1, wherein
the movement state acquisition unit acquires a movement speed of the moving object as the movement state, and
in response to the stop instruction while the moving object is being moved based on the movement instruction, the control unit increases the braking force to stop the moving object as the movement speed of the moving object increases.

3. The control device according to claim 1, wherein
the movement state acquisition unit acquires a weight of the moving object, and
in response to the stop instruction while the moving object is being moved based on the movement instruction, the control unit increases the braking force to stop the moving object as the weight increases.

4. The control device according to claim 1, wherein
the communication unit acquires communication quality between the moving object and the information terminal, and
in response to the stop instruction while the moving object is being moved based on the movement instruction, the control unit stops the moving object with a braking force corresponding to the movement state and the communication quality.

5. The control device according to claim 4, wherein
in response to the stop instruction while the moving object is being moved based on the movement instruction, the control unit increases the braking force to stop the moving object as the communication quality decreases.

6. The control device according to claim 1, wherein
the control unit acquires a delay time from when an instruction signal is transmitted from the information terminal to when the movement control based on the instruction signal is started, and
in response to the stop instruction while the moving object is being moved based on the movement instruction, the control unit stops the moving object with a braking force corresponding to the movement state and the delay time.

7. The control device according to claim 6, wherein
in response to the stop instruction while the moving object is being moved based on the movement instruction, the control unit increases the braking force to stop the moving object as the delay time increases.

8. The control device according to claim 6, wherein
the control unit stores the delay time when the moving object is being moved based on the movement instruction, and
in response to the stop instruction while the moving object is being moved based on the movement instruction, the control unit stops the moving object with a braking force corresponding to the movement state and the stored delay time.

9. The control device according to claim 1, wherein
the stop instruction is a first stop instruction or a second stop instruction with a higher emergency than the first stop instruction, and
in response to the second stop instruction, the control unit increases the braking force to stop the moving object as compared with when the first stop instruction is issued.

10. The control device according to claim 9, wherein
the movement instruction is issued when the information terminal receives a continuous first operation,
the first stop instruction is issued when the continuous first operation is interrupted, and
the second stop instruction is issued when the information terminal receives a second operation different from the continuous first operation.

11. The control device according to claim 10, wherein
the second operation is at least one of an operation of an emergency stop button and a voice input.

12. The control device according to claim 1, wherein
when the moving object is stopped not based on an instruction from the information terminal, the control unit stops the moving object with a braking force higher than when the moving object is stopped based on an instruction from the information terminal.

13. A control method of a moving object including a communication unit that communicates with an information terminal carried by a user of the moving object, a control unit that performs movement control on the moving object based on an instruction from the information terminal, and a movement state acquisition unit that acquires a movement state of the moving object, the instruction from the information terminal being a movement instruction to move the moving object or a stop instruction to stop the moving object, the control method comprising:
in response to the stop instruction while the moving object is being moved based on the movement instruction, stopping, by the control unit, the moving object with a braking force corresponding to the movement state.

14. A non-transitory computer-readable storage medium storing a control program for a moving object including a communication unit that communicates with an information terminal carried by a user of the moving object, a control unit that performs movement control on the moving object based on an instruction from the information terminal, and a movement state acquisition unit that acquires a movement state of the moving object, the instruction from the information terminal being a movement instruction to move the moving object or a stop instruction to stop the moving object, the control program causing the control unit to execute a process comprising:
in response to the stop instruction while the moving object is being moved based on the movement instruction, stopping the moving object with a braking force corresponding to the movement state.
